(19) United States
(12) Patent Application Publication
(10) Pub. No.: US 2015/0370772 A1
(43) Pub. Date: Dec. 24, 2015

(54) ANNOTATION PRESERVATION AS COMMENTS

(71) Applicant: Microsoft Corporation, Redmond, WA (US)

(72) Inventors: Shen Wang, San Jose, CA (US); Jennifer Sillik, Berkeley, CA (US)

(21) Appl. No.: 14/329,920

(22) Filed: Jul. 12, 2014

Related U.S. Application Data
(60) Provisional application No. 62/015,274, filed on Jun. 20, 2014.

(51) Int. Cl. G06F 17/24; G06F 17/21

(52) U.S. Cl. CPC G06F 17/241; G06F 17/211

(57) ABSTRACT

A user may be enabled to annotate a portion of a document through inking using touch inputs, such as a finger or stylus pen, gesture inputs, voice recognition, and/or eye-tracking, for example. The annotation may be recorded in a form of a comment card associated with the portion of the document. One or more annotation control elements may be provided in conjunction with the comment card to enable the user to perform various functions associated with the annotation and/or comment card. The document may then be displayed with one or both of the annotation and the comment card, such that the document may be re-used for presentation if desired. In some embodiments, the user may be enabled to playback the annotation on the displayed document and modify and/or delete the annotation during the playback. The user may further be enabled to annotate the portion of the document during a presentation.

### CROSS-REFERENCE TO RELATED APPLICATIONS

This application claims priority to U.S. Provisional Application Ser. No. 62/015,274 filed on Jun. 20, 2014. The Provisional application is herein incorporated by reference in its entirety.

### BACKGROUND

Applications such as word-processing, spreadsheet, and presentation applications enable interaction with documents, and may include commenting features to enable users to annotate a document with comments. Traditional methods of document annotation include keyboard and mouse input methods. However, commenting through such methods may not be optimized for devices with smaller screen sizes as the on-screen keyboard and comments themselves compete with document content for screen space on the user interface. Furthermore, after the commenting is complete, the annotations and the document content may remain separated, which may make it difficult to understand the commenter's intent.

Some recent implementations, such as touch input inking methods for document annotation, have been introduced to alleviate the competition for screen space on the user interface, and to better associate the annotations and the document content to provide a better understanding of the commenter's intent. However, these implementations permanently link the annotations together with the document content, making re-use of the document difficult. Furthermore, these implementations do not provide complete metadata associated with the annotations, such as who made the comment and when.

Accordingly, methods for document annotation could still use improvements and/or alternative or additional solutions, such that metadata associated with the annotations may be provided and the annotations may be easily hidden in order to enable re-use of the document in a presentation, for example, without losing the annotations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to preserving annotations of a document as comments. A user may be enabled to annotate a portion of a document through inking. The annotation may be recorded in form of a comment card associated with the portion of the document, and the document may be displayed with one or both of the annotation and the comment card.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a conceptual diagram illustrating an example networked configuration environment;

FIG. 2 illustrates an example inking module;

FIGS. 3A-3C illustrate an example process for preserving annotations of a document as comments;

FIGS. 4A and 4B illustrate another example process for preserving annotations of a document as comments;

FIG. 5 is a block diagram of an example general purpose computing device, which may be used to preserve annotations of a document as comments; and

FIG. 6 illustrates a logic flow diagram of a method to preserve annotations of a document as comments, according to embodiments.

### DETAILED DESCRIPTION

As briefly described above, a user may be enabled to annotate a portion of a document through inking. The inking may be employed using touch inputs, such as a finger or stylus pen, gesture inputs, voice recognition, and/or eye-tracking, for example. The annotation may be recorded in a form of a comment card associated with the portion of the document. One or more annotation control elements may be provided in conjunction with the comment card to enable the user to perform various functions associated with the annotation and/or comment card. The document may then be displayed with one or both of the annotation and the comment card. In some embodiments, the user may be enabled to playback the annotation on the displayed document and modify and/or delete the annotation during the playback. The user may further be enabled to annotate the portion of the document during a presentation of the document.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for annotation preservation as comments. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

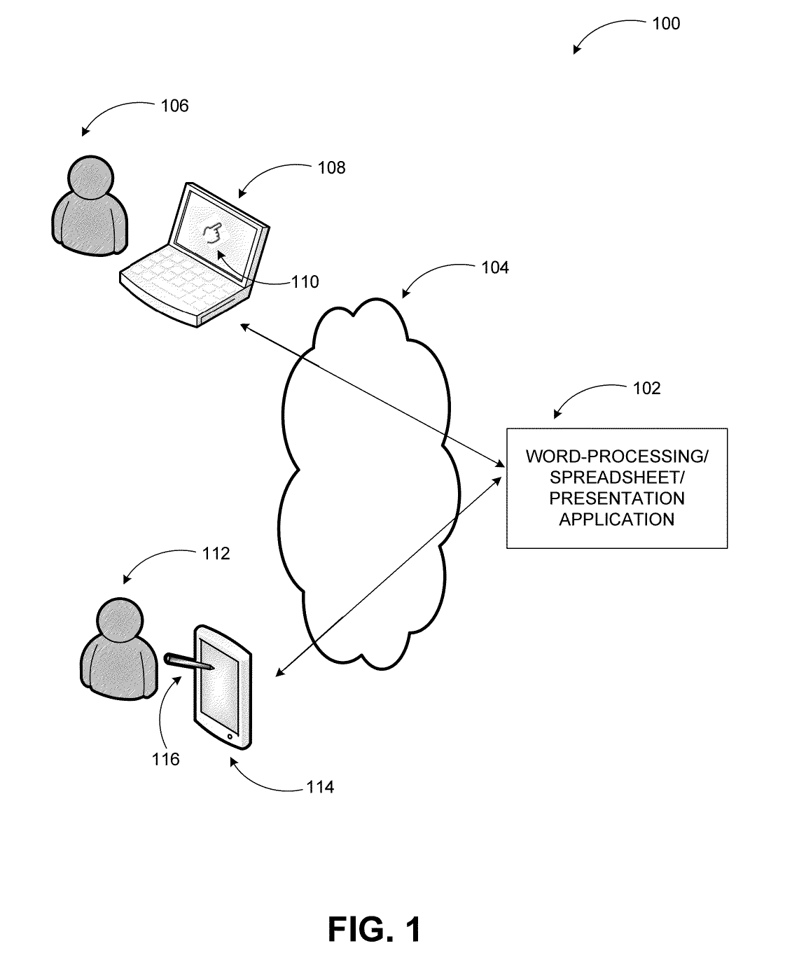

FIG. 1 includes a conceptual diagram illustrating an example networked configuration environment, where embodiments may be implemented. An application 102 such as a word-processing, a spreadsheet, or a presentation application may enable one or more users to create, view, edit, share, and present documents. The users may execute the application on one or more client devices, such as a desktop, a laptop, a tablet, a smart phone, or other similar device. Users may collaborate on documents to co-author and annotate shared documents. Documents maybe shared between the users over a network such as a cloud 104 to enable collaboration and co-authoring.

In one example embodiment, a first user 106 may execute the application 102 on a touch-enabled laptop computer 108 to view, edit, share, and/or present a document prepared by a second user 112. Upon execution, the application 102 may present the document to the first user 106. The first user 106 may be enabled to annotate a portion of the document through inking. The inking may be employed using touch inputs, such as a finger 110 or a stylus pen, gesture inputs, voice recognition, and/or eye-tracking for example. Other text-based comments may be inserted into the documents through traditional methods such as physical and/or on-screen keyboard inputs.

The annotation may be recorded in a form of a comment card. The comment card may be an individual container that holds one or more comments associated with the portion of a document and presented as such. The presentation of the comment card may be in various shapes and forms, such as a circle, a rectangle, and a square, among other shapes. In some examples, the comment card may be presented in a comment pane adjacent to the presented document along with one or more other comment cards associated with the text-based comments. One or more annotation control elements may be provided in conjunction with the comment card or as a separate user interface. The annotation control elements may include at least a “hide annotation” control element, a “show annotation” control element, a “playback annotation” control element, an “attach multimedia” control element, and a “synchronize multimedia” control element, among other elements. The “hide annotation” control element may enable a user to hide the annotation from a document display, and the “show annotation” control element may enable a user to display the annotation on the document. The “playback annotation” control element may enable a user to playback the annotation, where a user may modify and/or delete the annotation during the playback. The “attach multimedia” control element may enable a user to attach multimedia content, such as video content, audio content, and textual content, to the comment card. The “synchronize multimedia” control element may enable the multimedia content to be synchronized with the annotation to enable playback, and the synchronization may be based on a recorded timing during the annotation and/or a user defined timing. For example, the first user 106 may attach video content to the comment card employing the “attach multimedia” control element in order to supplement content in the annotated portion of the document for future presentation. The “synchronize multimedia” control element may then be employed to ensure that the video content and associated annotation are aligned properly when presented. The video content may be synchronized with the annotation based on a recorded timing during the annotation and/or a user defined timing.

The document may be displayed with one or both of the annotation and the comment card. For example, the first user 106 may employ the “show annotation” control element to overlay the annotation on the document for another user, such as the second user 112, to view. Alternately, the first user 106 may employ the “hide annotation” control element to remove the annotation from the displayed document such that the document may easily be re-used for a presentation. Although removed from display, the annotation is not deleted and may be displayed again in response to the first user 106 activating the “show annotation” control element, for example. The first user 106 may share the document with the second user 112 via the cloud 104 while the first user 106 is still viewing, editing, annotating, sharing, and/or presenting the document and/or once the first user 106 has finished viewing, editing, sharing, and/or presenting the document.

In order to access the document, the second user 112 may execute the application 102 to open the document on a touch-enabled device, such as a tablet 114. Upon opening the document, the application 102 may present the displayed document with one or both of the annotation and comment card generated by the first user 106. The comment card may include metadata associated with the annotation, such as a name of the first user 106 who authored the annotation, a time the first user 106 inked the annotation, a status of the annotation, and/or a content of the annotation. The status of the metadata may include characteristics of the annotation such as read, selected, new, and/or completed, for example. Similar to the first user 106, the second user 112 may be enabled to remove the annotation from the displayed document employing the “hide annotation” control element, or may display both the annotation and the comment card on the document employing the “show annotation” control element. The second user 112 may be enabled to playback the annotation generated by the first user 106, and modify and/or delete the annotation during the playback. The second user 112 may further annotate the same portion of the document or another portion of the document through inking, and the annotation may be recorded as a sub-comment in the comment card or as another comment card, respectively. The inking may be employed using touch inputs, such as a finger or a stylus pen 116, gesture inputs, voice recognition, and/or eye-tracking for example.

In some embodiments, if more than one annotation is associated with the portion of the document, the first user 106 and/or the second user 112 may be enabled to hide all annotations at once or show all annotations at once employing a “hide all annotations” control element and “show all annotations” control element, respectively. Furthermore, the first user 106 and/or the second user 112 may be able to set at least one of credential based and permission based limitations to control the annotations that are available for presentation to one or more other users. For example, the annotation generated by the first user 106 may only be able to be viewed by the second user 112.

The example systems in FIG. 1 have been described with specific network environments, client devices, applications, and interactions. Embodiments are not limited to systems according to these example configurations. Preserving annotations of a document as comments may be implemented in configurations employing fewer or additional components and performing other tasks. Furthermore, specific protocols and/or interfaces may be implemented in a similar manner using the principles described herein.

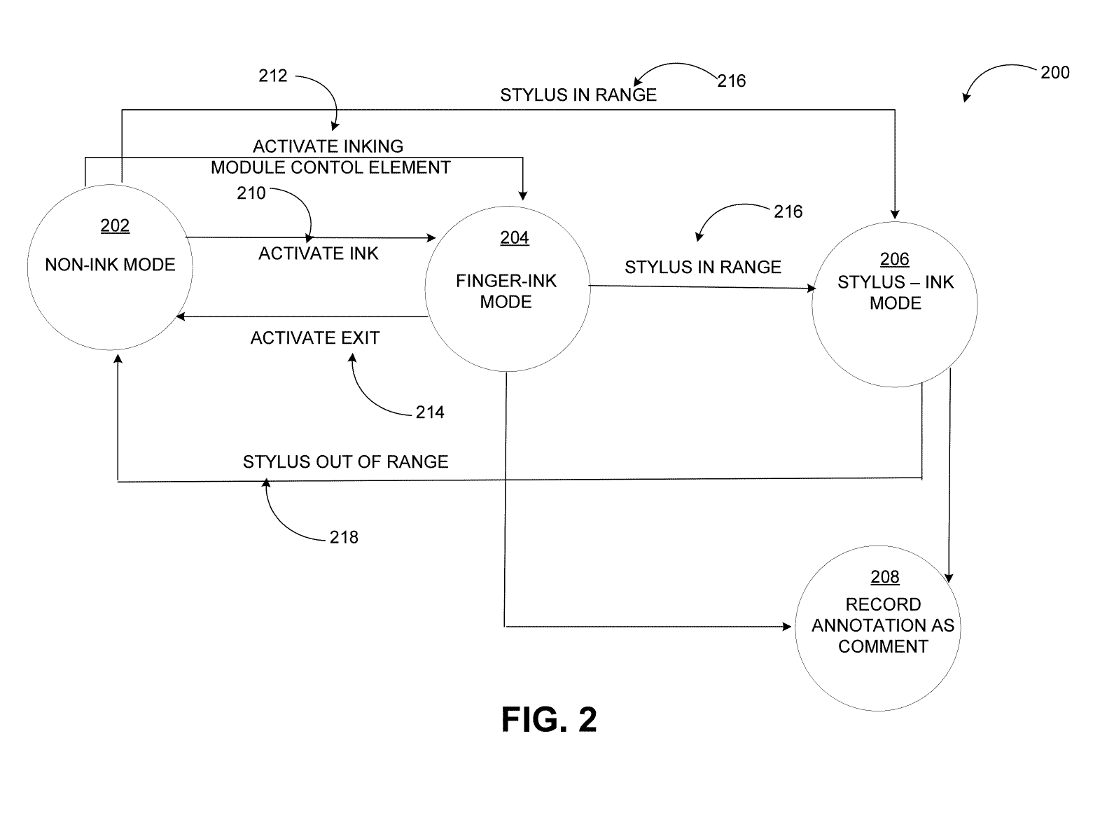

FIG. 2 illustrates an example inking module, according to some embodiments.

In diagram 200, an application such as a word-processing, a spreadsheet, or a presentation application that enables one or more users to create, view, edit, share, and present documents may include an inking module. The inking module of the application may enable a user to annotate a portion of a document through inking when in an ink mode (e.g., 204 and 206), and record the annotation as a comment 208. The ink mode may include a finger-ink mode 204 and a stylus-ink mode 206, for example. When the document is initially presented, the application may be automatically configured in a non-ink mode 202. In response to the user activating ink 210 through a control element of the application, such as an ink button, the application may be configured to a finger-ink mode 204. The application may also be configured to the finger-ink mode 204 in response to activation of an inking module control element 212, such as “pick a color” and/or “erase” control elements of the inking module. In response to the user exiting 214 the ink mode through the control element of the application, the application may be reconfigured to the non-ink mode 202.

In response to a detection of a stylus pen on and/or near a range of a user interface of the application presenting the document 216, the application may be configured to a stylus-ink mode 206 from either the non-ink mode 202 or the finger-ink mode 204. Accordingly, in response to a detection that the stylus pen is no longer on and/or is out of range of the user interface of the application presenting the document 218, the application may be reconfigured to the non-ink mode 202.

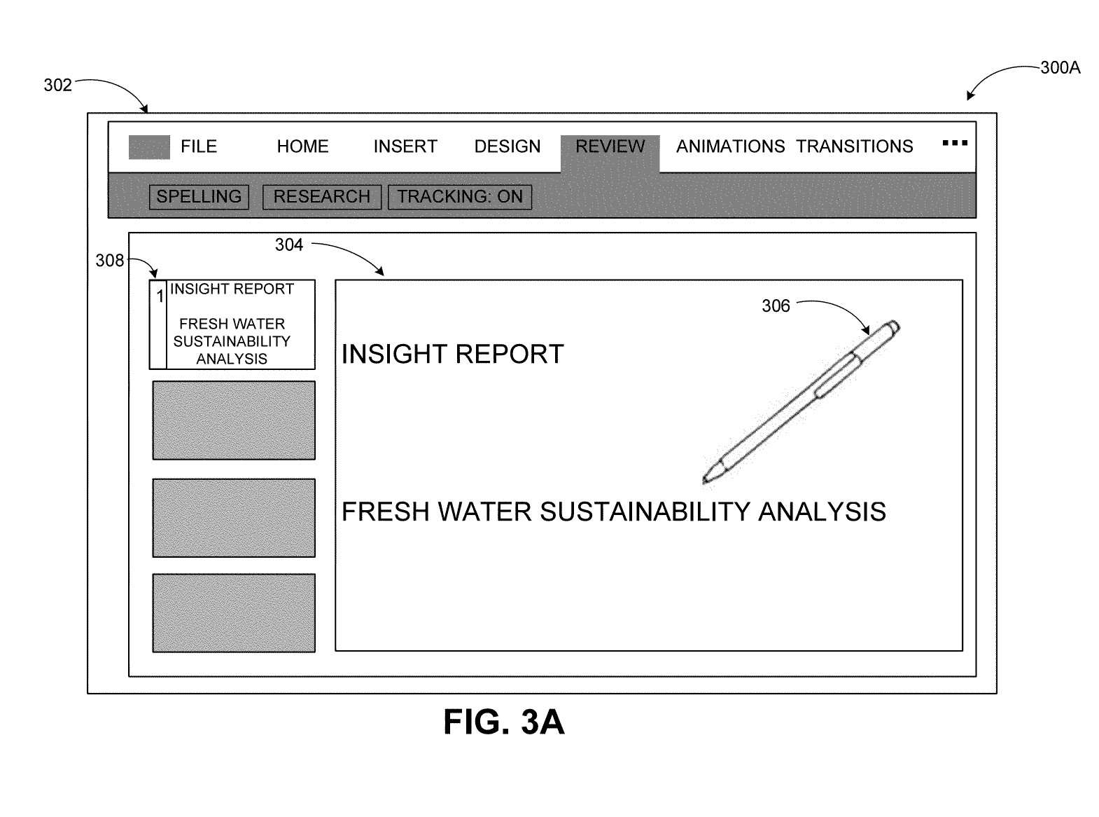

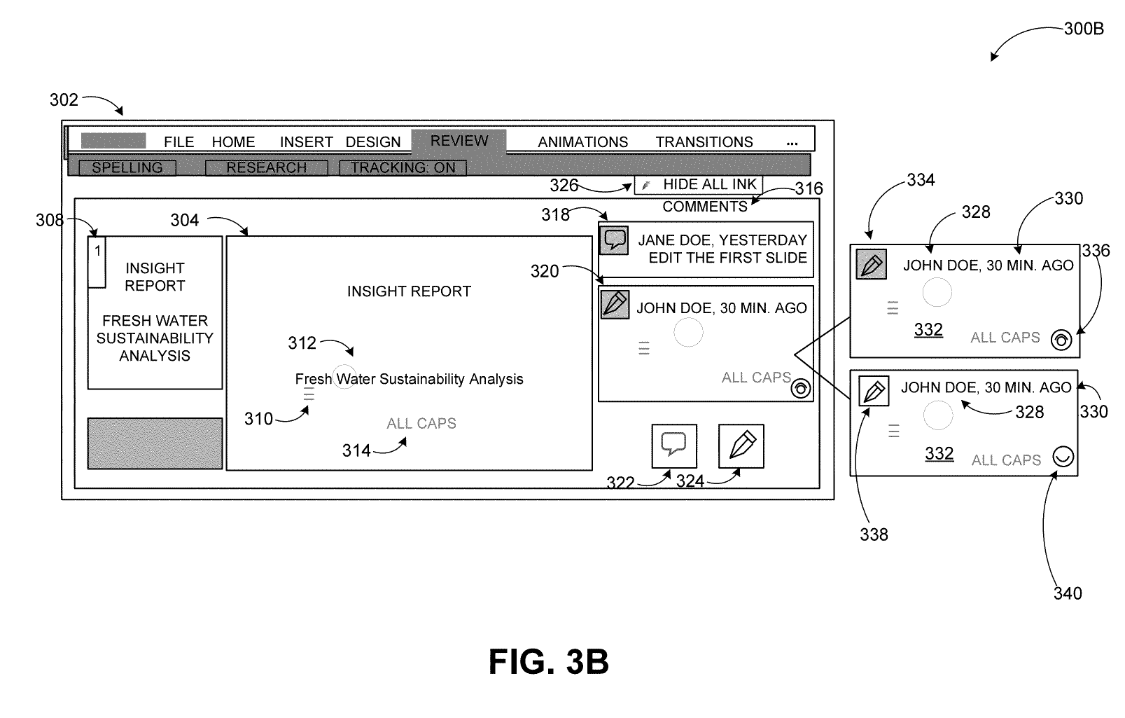

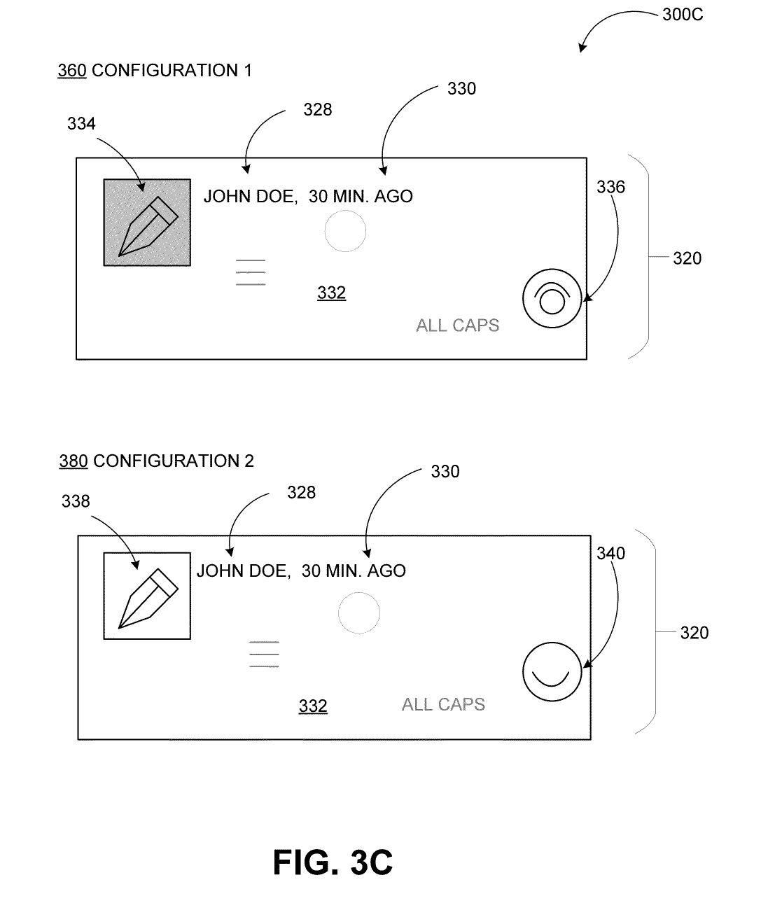

FIGS. 3A-3C illustrate an example user interface provided for annotating a document, according to some embodiments.

In diagram 300A, an application, such as a word-processing, spreadsheet, and/or presentation application, executed on a device may present a document 304 for a user to view, edit, share, and/or present on a user interface 302. The user may be enabled to annotate a portion of the document 304, such as a first slide 308 of the document 304, through inking. Inking may be employed using one or more input methods, such as a touch input, as illustrated by the stylus pen 306. Other input methods may include a finger touch input, a gesture input, voice recognition, and/or eye-tracking, among other methods. In an example scenario, the user may be editing the document 304 in preparation for a presentation.

In diagram 300B, the user may annotate the first slide 308 of the document 304 through inking using the stylus pen. A first annotation 310 may include multiple vertical lines below the letter F on the first slide 308 of the document 304, a second annotation 312 may include a circling of the letter “W” on the first slide 308 of the document 304, and a third annotation 314 may additionally specify for all letters to be capitalized on the first slide 308 of the document 304 indicated by the note “Allcaps”. The annotations may be recorded as comments in the form of a comment card 320 associated with the portion of the document 304, and therefore the first slide 308 of the document 304. The comment card 320 may be displayed in a comment pane 316 of the user interface 302 of the application presenting the document 304, which may be adjacent to the document 304. The comment pane 316 may also include one or more other comment cards 318 associated with text-based comments and various control elements (e.g., 322 and 324) enabling user interaction with the comment pane 316. The other comment cards 318 associated with text-based comments may include textual content associated with the document that were inserted by the user or other users via typing through physical and/or on-screen keyboard input methods, for example. A first control element 322 may enable the user to add one or more other text-based comments, and a second control element 324 may enable the user to further annotate the same portion of the document 304 and/or annotate another portion of the document 304. Within the comment pane 316, the user may also be able to reply to each comment card (e.g., 318 and 320) and/or update a status of each comment card (e.g., 318 and 320). The status may include characteristics of the comments and/or annotations such as read, selected, new, and/or completed.

The comment card 320 may include metadata associated with the annotations (e.g., 310, 312, and 314). Example metadata may include an author 328 of the annotations, a time 330 the annotations were inked, and a content 332 of the annotations. The comment card 320 may also include a first icon 334 corresponding to a “show annotation” control element 336 and a second icon 338 corresponding to a “hide annotation” control element 340 on the comment card 320. In some examples, the comment card 320 may include a single icon with an associated label that alternates between “show” and “hide” dependent on if the user has activated the “show annotation” control element 336 or the “hide annotation” control element 340. For example, the user may activate the “show annotation” control element 336 to show the annotations (e.g., 310, 312, and 314) corresponding to the comment card 320 such that they are overlaid on the document 304 for display, as illustrated in diagram 300B. Alternately, the user may activate the “hide annotation” control element 340 to hide the annotations (e.g., 310, 312, and 314) corresponding to the comment card 320 such that they are removed from the document display. Although removed from display, the annotations (e.g., 310, 312, and 314) are not deleted, and may be displayed again in response to the user activating the “show annotation” control element 336, for example. The first icon 334 and the second icon 338 may be graphically distinct. For example, a background of the first icon 334 may be darker and a background of the second icon 338 may be lighter. Additionally, the user interface 302 of the application presenting the document 304 may include a “show all/hide all ink” control element 326 that the user may activate to either show all the annotations associated with the first slide 308 of the document 304 generated by the user and one or more other users such that they are displayed on the document 304 and hide all the annotations such that they are removed from the document display.

In diagram 300C, two configurations of the comment card 320, discussed in conjunction with the diagram 300B, are illustrated in detail. In response to the user annotating a portion of a document, such as the first slide 308 of the document 304, through inking, the annotation may be recorded as a comment in a form of the comment card 320 associated with the portion of the document. The comment card 320 may include metadata associated with the annotation. Example metadata may include an author 328 of the annotation, a time 330 the annotation was inked, and a content 332 of the annotation. In a first configuration 360, the comment card 320 may include a first icon 334 corresponding to a “show annotation control” element 336. When the “show annotation” control element 336 is activated by the user, the content 332 of the annotation is displayed on the document along with the comment card 320.

In a second configuration 380, the comment card 320 may include a second icon 338 corresponding to a “hide annotation” control element 340. The user may activate the “hide annotation” control element 340 to hide the content of the annotation such that they are removed from the document display. As illustrated, the first icon 334 and the second icon 338 may be graphically distinct. For example, the first icon 334 may have a darker background color scheme than the second icon 338. In other examples, the first icon 334 and the second icon 338 may be displayed distinctly on the comment card using a textual scheme, a graphical scheme, an animation scheme, a coloring scheme, a highlighting scheme, and/or a shading scheme, among other schemes.

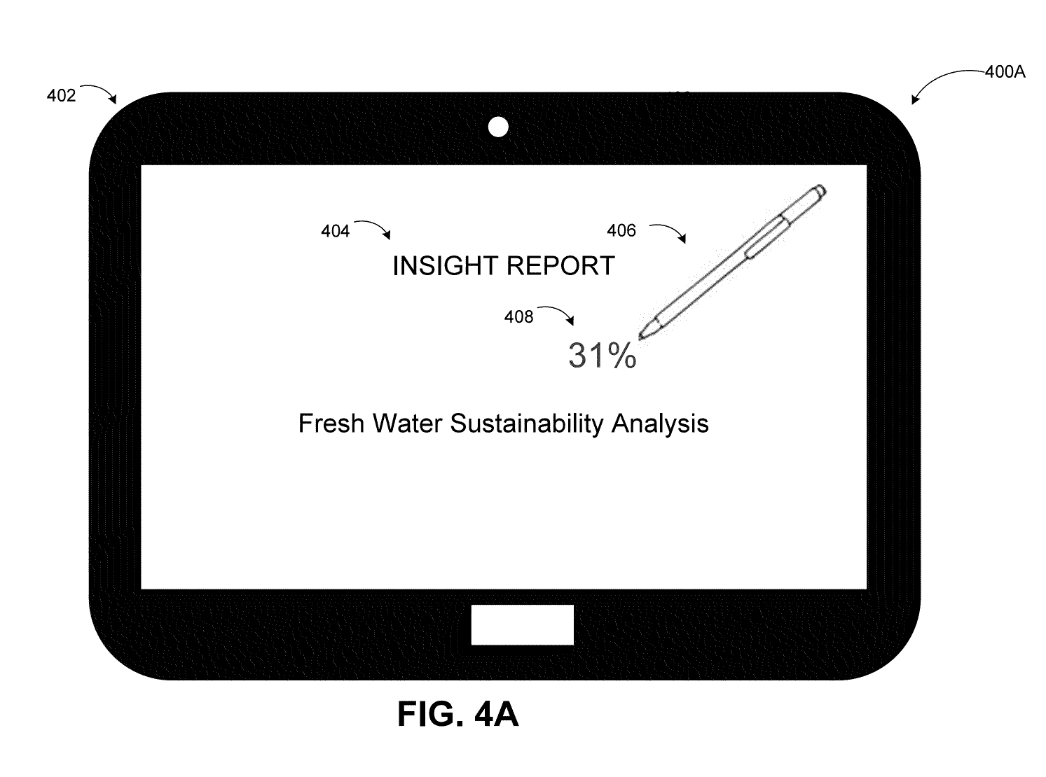

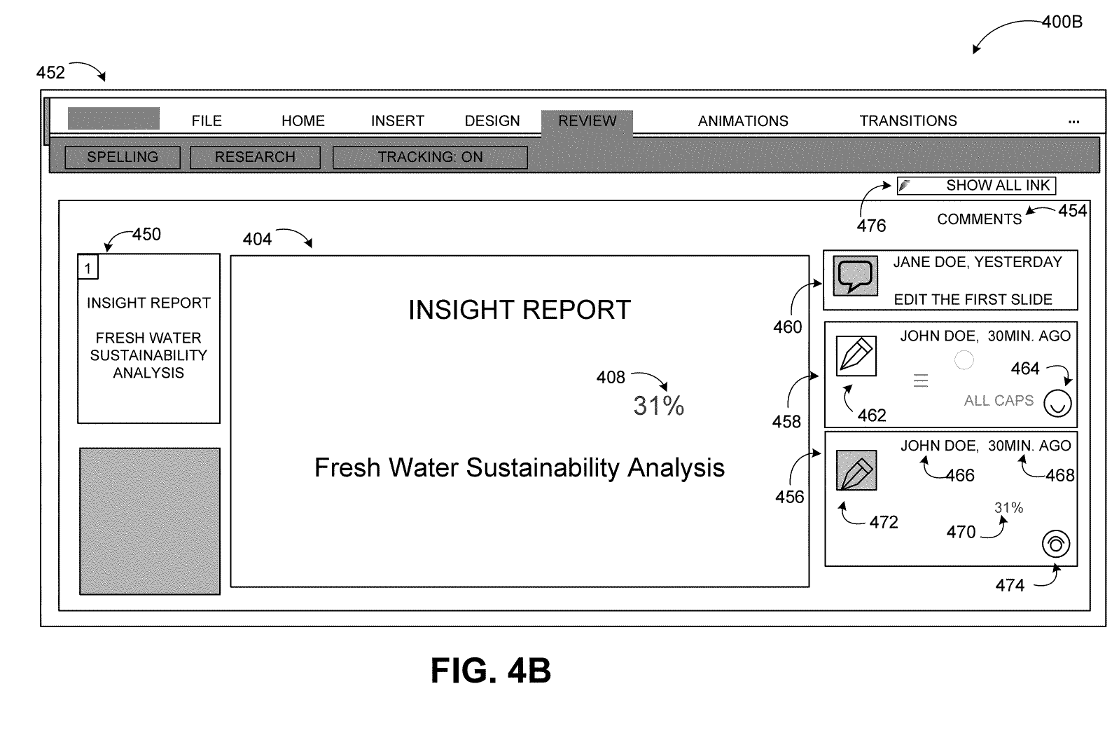

FIGS. 4A and 4B illustrate another example process for preserving annotations of a document as comments, according to some embodiments.

In diagram 400A, an application, such as a word-processing, a spreadsheet, or a presentation application, may be executed on a touch-enabled device, such as a tablet 402. A user may open a document 404 through the application for presentation, for example. The document may have been previously viewed and/or annotated, similar to the example scenario described in conjunction with FIGS. 3A-3C. During the presentation of the document 404, the user may be enabled to annotate a portion of the document 404 through inking using a stylus pen 406, as illustrated. For example, the user may annotate 408 a slide of the document 404 to include “31%”. In some examples, through voice recognition, the user may also include the intent of 31%, such as “31% of fresh water sources are contaminated weekly” as another annotation associated with the slide of the document 404. The annotation 408 may be recorded in a form of a comment card that includes metadata associated with the one or more annotations.

In diagram 400B, the annotated slide 450 of the document 404 may be displayed on a user interface 452 of the application following completion of the presentation. As discussed previously, the annotation 408 may be recorded as a comment. A comment card 456 holding the recorded comment may be displayed in a comment pane 454 of the user interface 452 of the application, which may be adjacent to the displayed document 404. The comment pane 454 may also include one or more other comment cards associated with text-based comments 460 that may include comments associated with the annotated slide 450 of the document 404 that were inserted by the user or other users via typing through physical and/or on-screen keyboard input methods prior to the presentation, for example. The comment pane 454 may further include one or more comment cards corresponding to previous annotations 458 associated with the annotated slide 450 of the document 404. For example, if the document 404 was edited prior to the presentation previous annotations may have been made. The previous annotations may be removed from the document display or may be shown along with more recent annotations. For example, the comment card corresponding to the previous annotation 458 may display a first icon 462 corresponding to a “hide annotation” control element 464 such that content of the previous annotation is not displayed on the document 404. Although removed from display, the previous annotation is not deleted, and may be displayed again in response to the user activating a “show annotation” control element, for example. Within the comment pane 454, the user may also be able to reply to each comment card (e.g., 456, 458, and 460) and/or update a status of each comment card (e.g., 456, 458, and 460). The status may include characteristics of the comments and/or annotations such as read, selected, new, and/or completed.

The comment card 456 may include metadata associated with the annotation 408. Example metadata may include an author 466 of the annotation 408, a time 468 the annotation 408 was inked, and a content 470 of the annotation 408. The comment card may also include a second icon 472 corresponding to the “show annotation” control element 474 on the comment card 456 such that annotation 408 is overlaid on the document 404 for display, as illustrated in diagram 400B. Additionally, the user interface 452 of the application may include a “show all/hide all” ink control element 476 that the user may activate to one of show all the annotations associated with the document 404 created by the user and one or more other users such that they are displayed on the document 404 and hide all the annotations such that they are removed from the document display.

The examples in FIGS. 1 through 4 have been described with specific platforms including servers, applications, modules, and user interface interactions. Embodiments are not limited to systems according to these example configurations. Preservation of annotations as comments may be implemented in configurations using other types of platforms including servers, applications, modules, and user interface interactions in a similar manner using the principles described herein.

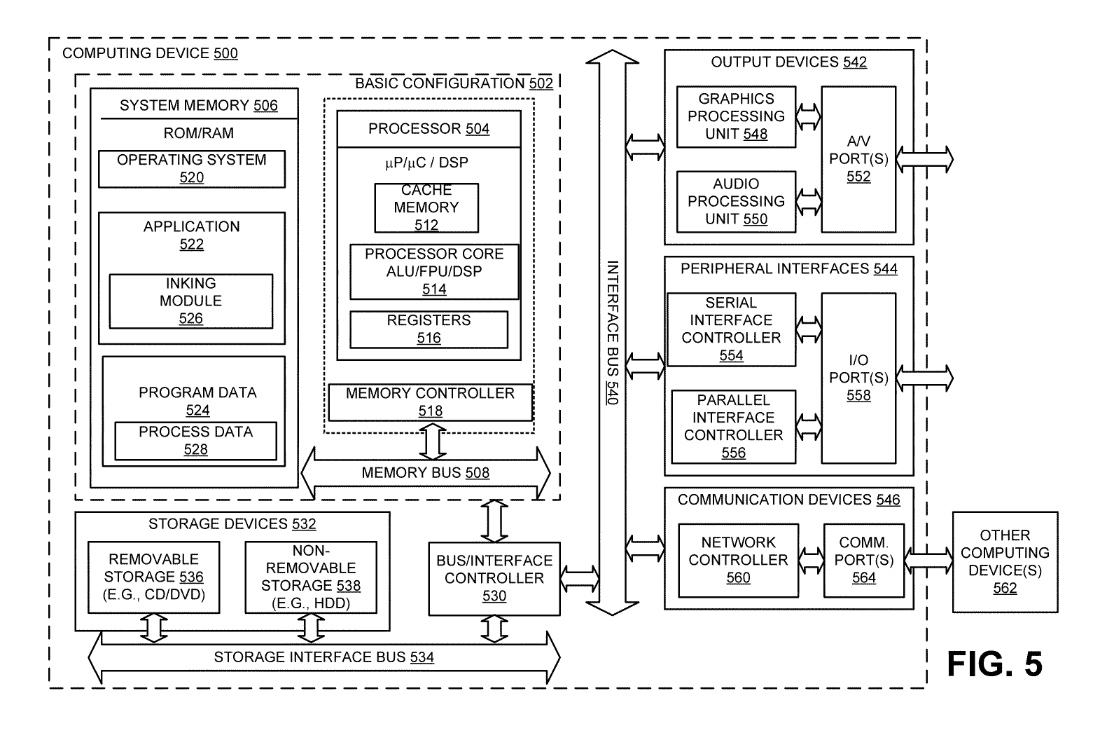

FIG. 5 and the associated discussion are intended to provide a brief, general description of a general purpose computing device, which may be used to preserve annotations of a document as comments, arranged in accordance with at least some embodiments described herein.

For example, computing device 500 may be used as a server, desktop computer, portable computer, smart phone, special purpose computer, or similar device. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The example processor cores 514 may (each) include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, an application 522, and program data 524. The application 522 may include an inking module 526, which may be an integral part of the application or a separate application on its own. The inking module 526 may be configured to enable a user to annotate a portion of a document through inking, record the annotation in a form of a comment card associated with the portion of the document, and display the document with one or both of the annotation and the comment card. The program data 524 may include, among other data, process data 528 such as metadata associated with the annotation, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536 and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and one or more communication devices 546) to the basic configuration 502 via the bus/interface controller 530. Some of the example output devices 542 include a graphics processing unit 548 and an audio processing unit 550, which may be configured to communicate to various external devices such as a display or speakers via one or more A/V ports 552. One or more example peripheral interfaces 544 may include a serial interface controller 554 or a parallel interface controller 556, which may be configured to communicate with external devices such as input devices (for example, keyboard, mouse, pen, voice input device, touch input device, etc.) or other peripheral devices (for example, printer, scanner, etc.) via one or more I/O ports 558. An example communication device 546 includes a network controller 560, which may be arranged to facilitate communications with one or more other computing devices 562 over a network communication link via one or more communication ports 564. The one or more other computing devices 562 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods to preserve annotations of a document as comments. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

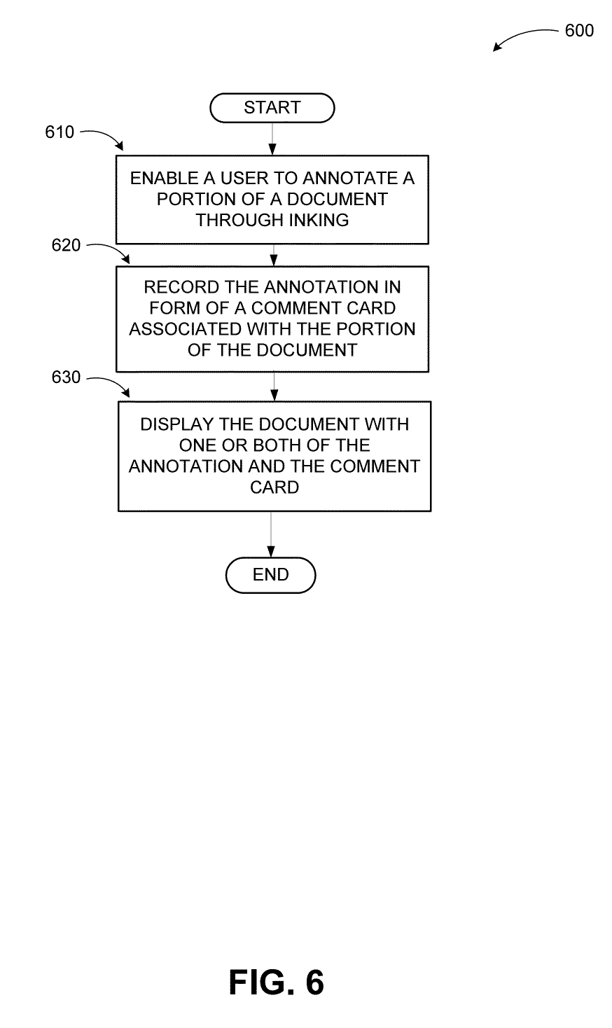

FIG. 6 illustrates a logic flow diagram for process 600 of a method to preserve annotations of a document as comments, according to embodiments.

Process 600 may be implemented on a server or other system. Process 600 begins with operation 610, where a user may be enabled to annotate a portion of a document through inking. The document may be presented through an executed application such as a word-processing application, spreadsheet, and/or presentation application. The user may be enabled to annotate the portion of the document through inking, which may be employed using touch inputs, such as a finger or stylus pen, gesture inputs, voice recognition, and/or eye-tracking.

At operation 620, the annotation may be recorded as a comment in form of a comment card associated with the portion of the document. The comment card may include metadata associated with the annotation, such as an author of the annotation, a time the annotation was inked, a status of the annotation, and a content of the annotation, for example. One or more annotation control elements may be provided in conjunction with the comment card or as a separate user interface. The annotation control elements may include at least a “hide annotation” control element, a “show annotation” control element, a “playback annotation” control element, an “attach multimedia” control element, and a “synchronize multimedia” control element, among other elements. The “hide annotation” control element may enable the user to remove the annotation from a document display, and the “show annotation” control element may enable the user to display the annotation on the document. The “playback annotation” control element may enable a user to playback the annotation, where a user may modify and/or delete the annotation during the playback. The “attach multimedia” control element may enable the user to attach multimedia content, such as video content, audio content, and textual content, to the comment card. The “synchronize multimedia” control element may enable the multimedia content to be synchronized with the annotation to enable playback, and the synchronization may be based on a recorded timing during the annotation and/or a user defined timing.

At operation 630, the document may be displayed with one or both of the annotation and the comment card. For example, the user may employ the “hide annotation” control element to remove the annotation from the displayed document to enable easy re-use of the document for presentation. Although removed from display, the annotation is not deleted, and may be displayed again in response to the user employing the “show annotation” control element, for example.

The operations included in process 600 are for illustration purposes. Preservation of annotations as comments may be implemented by similar processes with fewer or additional steps, as well as in different order of operations using the principles described herein.

In some examples, methods are provided to preserve annotations of a document as comments. An example method, executed at least in part on a computing device, may enable a user to annotate a portion of a document through inking, record the annotation in form of a comment card associated with the portion of the document, and display the document with one or both of the annotation and the comment card.

In other examples, one or more annotation control elements are provided in conjunction with the comment card or as a separate user interface. A “show annotation” control element may be provided that enables the user to overlay the annotation on the document such that the document is displayed with both of the annotation and the comment card. A “hide annotation” control element may be provided that enables the user to remove the annotation from the document display. The user may be enabled to playback the annotation on the displayed document, and the user may be enabled to delete and/or modify the annotation during the playback.

In further examples, multimedia content associated with the annotation may be attached to the comment card, and synchronized with the annotation based on at least one of a recording time during the annotation and a user defined timing to enable playback, where the multimedia content may include video content, audio content, and/or textual content. The user may be enabled to annotate the portion of the document during a presentation of the document. The user may be enabled to set at least one of credential based and permission based limitations to control the annotation's availability for presentation to one or more other users. The user may be enabled to annotate the portion of the document through inking by employing one or more of: touch input, gesture input, voice recognition, and eye tracking.

In some embodiments, computing devices configured to preserve annotations of a document as comments are described. An example computing device include a memory, and a processor coupled to the memory, the processor executing an application. The application may be configured to enable a user to annotate a portion of a document through inking, record the annotation in form of a comment card associated with the portion of the document, and display the document with one or both of the annotation and the comment card.

In other embodiments, the comment card may include metadata associated with the annotation, where the metadata includes at least an author of the annotation, a time the annotation was inked, a status of the annotation, and a content of the annotation. One or more annotation control elements provided in conjunction with the comment card may include at least a “hide annotation” control element, a “show annotation” control element, a “playback annotation” control element, an “attach multimedia” control element, and a “synchronize multimedia” control element. The application may be executed in a collaborative environment enabling one or more other users view, share, edit, annotate, and/or present the document. The application may execute an inking module to enable the user to annotate the portion of the document through inking.

In some examples, a computer-readable memory device with instructions stored thereon to preserve annotations of a document as comments is described. Example instructions may include enabling a user to annotate a portion of a document through inking and recording the annotation in form of a comment card associated with the portion of the document, where one or more annotation control elements are provided in conjunction with the comment card. The example instructions may also include displaying the document with one or both of the annotation and the comment card employing at least one of the one or more annotation control elements; and enabling the user to playback the annotation on the displayed document.

In other examples, displaying the document with one or both of the annotation and the comment card employing at least one of the one or more annotation control element may further include providing a “show annotation” control element that enables the user to overlay the annotation on the document such that the document is displayed with both of the annotation and the comment card, and providing a “hide annotation” control element that enables the user to remove the annotation from the document display.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method, executed at least in part on a computing device, to preserve annotations of a document as comments, the method comprising:
enabling a user to annotate a portion of a document through inking;
recording the annotation in form of a comment card associated with the portion of the document; and
displaying the document with one or both of the annotation and the comment card.

2. The method of claim 1, further comprising:
providing one or more annotation control elements in conjunction with the comment card; and
providing the one or more annotation control elements as a separate user interface.

3. The method of claim 2, further comprising:
providing a “show annotation” control element that enables the user to overlay the annotation on the document such that the document is displayed with both of the annotation and the comment card.

4. The method of claim 3, further comprising:
providing a “hide annotation” control element that enables the user to remove the annotation from the document display.

5. The method of claim 1,
enabling the user to playback the annotation.

6. The method of claim 5, further comprising:
enabling the user to one of delete and modify the annotation during the playback.

7. The method of claim 1, further comprising:
attaching multimedia content associated with the annotation to the comment card.

8. The method of claim 7, further comprising:
synchronizing the multimedia content to the annotation based on at least one of a recorded timing during the annotation and a user defined timing to enable playback.

9. The method of claim 7, wherein the multimedia content includes one or more of video content, audio content, and textual content.

10. The method of claim 1, further comprising:
enabling the user to annotate the portion of the document during a presentation of the document.

11. The method of claim 1, further comprising:
enabling the user to set at least one of credential based and permission based limitations to control presentation of the annotation to one or more other users.

12. The method of claim 11, further comprising:
enabling the user to annotate the portion of the document through inking by employing one or more of: touch input, gesture input, voice recognition, and eye tracking.

13. A computing device configured to preserve annotations of a document as comments, the computing device comprising:
a memory;
a processor coupled to the memory, the processor executing an application configured to:
enable a user to annotate a portion of a document through inking;
record the annotation in form of a comment card associated with the portion of the document; and
display the document with one or both of the annotation and the comment card.

14. The computing device of claim 13, wherein the comment card includes metadata associated with the annotation.

15. The computing device of claim 14, wherein the metadata includes at least an author of the annotation, a time the annotation was inked, a status of the annotation, and a content of the annotation.

16. The computing device of claim 13, wherein one or more annotation control elements provided in conjunction with the comment card include at least a “hide annotation” control element, a “show annotation” control element, a “playback annotation” control element, an “attach multimedia” control element, and a “synchronize multimedia” control element.

17. The computing device of claim 13, wherein the application is executed in a collaborative environment enabling one or more other users to one of view, share, edit, annotate, and present the document.

18. The computing device of claim 13, wherein the application executes an inking module to enable the user to annotate the portion of the document through inking.

19. A computer-readable memory device with instructions stored thereon to annotate a document, the instructions comprising:
enabling a user to annotate a portion of a document through inking;
recording the annotation in form of a comment card associated with the portion of the document, wherein one or more annotation control elements are provided in conjunction with the comment card;
displaying the document with one or both of the annotation and the comment card employing at least one of the one or more annotation control elements; and
enabling the user to playback the annotation on the displayed document.

20. The computer-readable memory device of claim 19, wherein displaying the document with one or both of the annotation and the comment card employing at least one of the one or more annotation control element further comprises:
providing a “show annotation” control element that enables the user to overlay the annotation on the document such that the document is displayed with both of the annotation and the comment card; and
providing a “hide annotation” control element that enables the user to remove the annotation from the document display.
